(19) United States
(12) Patent Application Publication
(10) Pub. No.: US 2023/0278325 A1
(43) Pub. Date: Sep. 7, 2023

(54) PRINTED OVERLAY FOR APPLIANCE CONTROL PANEL

(71) Applicant: NuWave, LLC, Vernon Hills, IL (US)

(72) Inventors: Jung S. Moon, Long Grove, IL (US); Zeng Qing Ping, Shanwei City (CN); Luo Fei, Foshan City (CN)

(21) Appl. No.: 17/653,591

(22) Filed: Mar. 4, 2022

(51) Int. Cl. B32B 38/00; B41M 1/12; B41M 1/30; B32B 37/12; B32B 7/12; B32B 27/30; B32B 27/06

(52) U.S. Cl. CPC B32B 38/145; B32B 7/12; B32B 27/06; B32B 27/308; B32B 37/12; B41M 1/12; B41M 1/30; F24C 7/082

(57) ABSTRACT

An overlay for an appliance control panel having an outer panel with relevant indicia printed onto a back surface and a contrasting backing film applied to the back surface of the outer panel over the printed relevant indicia. The relevant indicia is printed in reverse to provide a proper display when the overlay is attached to an appliance control panel. The method for producing this durable user interface panel for an appliance having a digital control panel is also disclosed.

### TECHNICAL FIELD OF THE INVENTION

The present disclosure relates to printed control panels for appliances. More specifically, the disclosure relates to printed overlays for a control panel.

### BACKGROUND OF THE INVENTION

As more and more appliances move to digital controls with touchscreen and push-button user interfaces, the need for more reliable labeling on these screens and buttons becomes of great importance. This is particularly true where an appliance has several similar input buttons. Mistakenly selecting “broil” when you wanted “bake” or “high” when you wanted “low” or increasing “time” when you wanted to lower “temperature” could be critical errors in food preparation and cooking.

However, over time, the repeated touching and cleaning of user input control panels can cause the labels to wear-off. This can lead users to guess at correct input buttons based on personal memory and/or any display which occurs, relabel the panel in some manner-e.g., markers, colored stickers-with varying degrees of success, or discard an otherwise working appliance. Each of these solutions is undesirable.

The industry needs a durable user interface that retains markings despite repeated touching and cleaning. Until the invention of the present application, these and other problems in the prior art went either unnoticed or unsolved by those skilled in the art. The present invention provides a durable interface screen and a method for producing the same. The resulting screen is capable of use with any type of appliance without sacrificing functionality, features, design, aesthetics, or affordability.

### SUMMARY OF THE INVENTION

There is disclosed herein an improved printed overlay for a control panel or user interface panel for an appliance which avoids the disadvantages of prior devices while affording additional structural and operating advantages.

Generally speaking, the overlay comprises an outer panel having relevant indicia printed onto a back surface and a contrasting backing film applied to the back surface of the outer panel over the printed relevant indicia. The relevant indicia is printed in reverse to provide a proper display when the overlay is attached to an appliance control panel.

Further, the method for producing a durable user interface panel for an appliance having a digital control panel is also disclosed. The method comprises printing relevant insignia in reverse onto a back surface of a clear panel sized to fit over an area of a digital control panel of an appliance, underlaying a contrasting film onto the printed back surface of the clear panel to create a control screen overlay, then attaching the control screen overlay to an area of the digital control panel of an appliance such that the contrasting film is sandwiched between the digital control panel and the clear panel.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a front view of a control panel produced by an embodiment of the disclosed method;

FIG. 2 is a schematic illustration of an embodiment of the disclosed control panel overlay; and

FIG. 3 is a schematic illustration of a film being applied onto a back surface of a transparent printed panel to produce an overlay for an appliance digital control panel.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

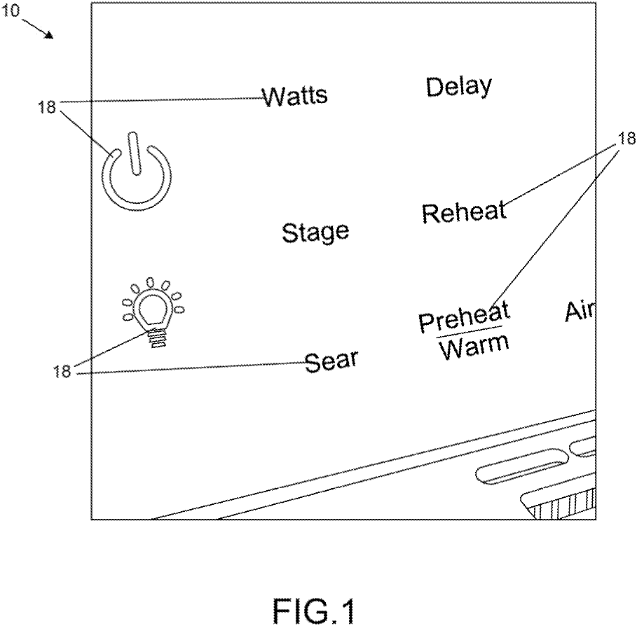

Referring to FIGS. 1-3, there is illustrated an embodiment of a printed overlay for an appliance digital control panel. The particular illustrated digital control panel, generally indicated by the reference number 10, is for a convection oven or air fryer appliance. However, while the embodiment illustrated and described is directed to a cooking appliance, it should be understood that the principles of the invention can be more broadly applied to other appliances having digital control panels, such as blenders, air filtering units, heaters, and similar electronic devices.

A digital control panel is typically comprised of a capacitive screen having a small electrical charge evenly applied across its surface-though, the disclosed invention may also be suitable for use on resistive touchscreens. When a capacitive screen is touched by, for example, a bare finger, some of the charge is absorbed changing the electrical charge at the point of contact. This change in charge is then read by software to determine a location on the screen for the point of contact. The software then executes a control command corresponding to the point of contact. Unfortunately, all this screen contact, including occasional cleaning, results in removing important instructive indicia on the control panel, as indicia is printed on the outer surface of the panel. Without knowing where to touch the screen for specific operations of the appliance, users are left to guess. This is particularly true where the appliance is located in a common area-e.g., a cafeteria, lunchroom, break room, lobby or the like.

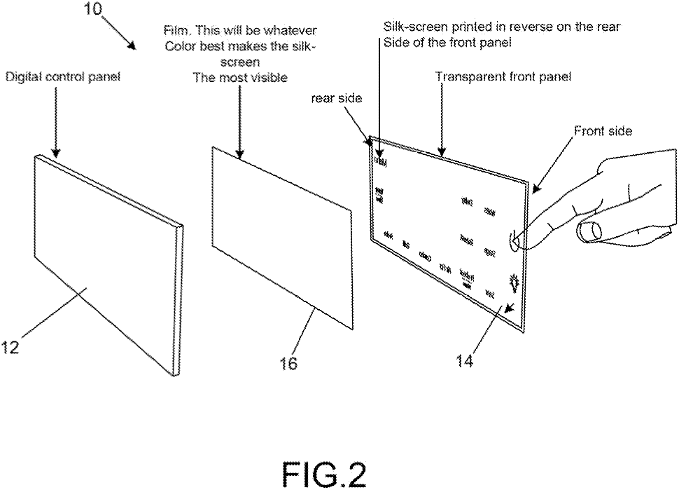

As can be seen in FIGS. 1 and 2, the disclosed durable user interface control panel 10 is generally comprised of a digital panel 12, an outer printed panel 14 having indicia 18, and a backing film 16. The digital panel 12 comprises an electric charge, so it is important that the printed panel 14 and backing film 16 do not interfere with the touchscreen functionality.

Preferably, printing of relevant indicia 18 onto panel 14 is done using a silk-screening method. By “relevant indicia” it is meant any words, images, or icons that are used on an interface panel to convey function, status, instructions, brand, trademark, or aesthetics. The silk-screening is done on the inside surface 20 of the panel 14 in reverse. That is, the indicia 18 are printed backwards so that they appear correctly when completed. The panel 14 must be transparent or substantially translucent to allow all printed indicia 18 to be visible. Preferably, the panel 14 is made of an acrylic or similar material, as is known in the art, and has a suitable thickness for control panels.

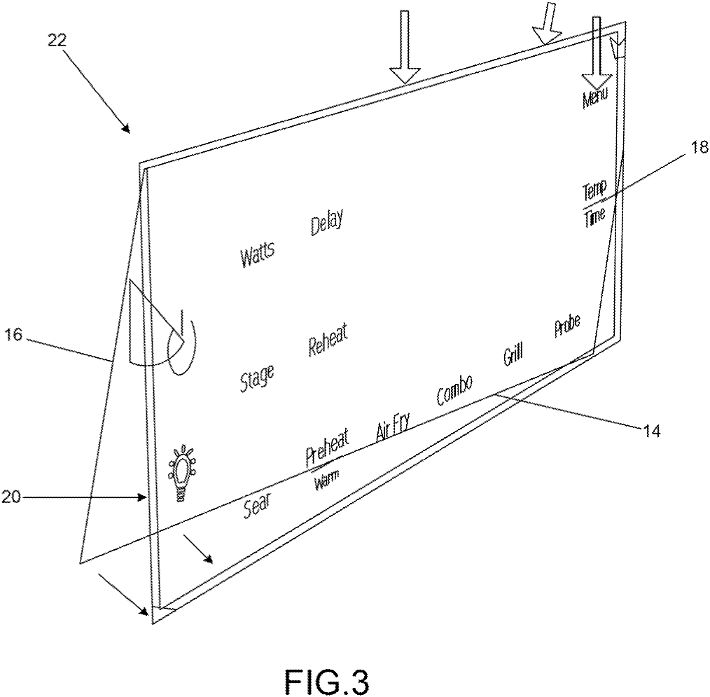

As shown in FIG. 3, the contrasting backing film 16 is then placed against the backside surface 20 of panel 14. Preferably, the film 16 is a double-sided adhesive film comprised of a polyvinyl substrate or similar material, as is known in the art, with an acrylic or similar adhesive on both sides. The color of the film 16 must be selected to accentuate the indicia 18 and facilitate visibility in most light conditions. Together, the film 16 and printed panel 14 create a control panel overlay 22.

The overlay 22 is then placed over the digital control panel 12, aligning the indicia 18 with the necessary button sensors (not shown). In this manner, the indicia 18 are very visible, but are protected against fading and being scratched or worn-off over time.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants’ contribution. The actual scope of the protection sought is intended to be defined in the following claims when viewed in their proper perspective based on the prior art.

What is claimed is:

1-4. (canceled)

5. An overlay for an appliance control panel, the overlay comprising:
an outer panel having relevant indicia printed onto a back surface; and
a contrasting backing film applied to the back surface of the outer panel over the printed relevant indicia;
wherein the relevant indicia is printed in reverse to allow proper display of the indicia when the overlay is attached to an appliance control panel.

6. The overlay of claim 5, wherein the relevant indicia is applied to the back surface of the outer panel through silk-screening.

7. The overlay of claim 5, wherein the outer panel is transparent.

8. The overlay of claim 7, wherein the outer panel is comprised of an acrylic material.

9. The overlay of claim 5, wherein the contrasting film accentuates the printed indicia on the outer panel.

10. The overlay of claim 9, wherein the contrasting film is comprised of a double-sided adhesive polyvinyl sheet.
